(19) United States
(12) Patent Application Publication
(10) Pub. No.: US 2015/0010443 A1
(43) Pub. Date: Jan. 8, 2015

(54) REAGENT CONTAINER FOR BIOLOGICAL SAMPLE ANALYZER AND METHOD FOR MANUFACTURING REAGENT CONTAINER

(71) Applicant: Sysmex Corporation, Kobe-shi (JP)

(72) Inventor: Fuminari HASEGAWA, Kobe-shi (JP)

(21) Appl. No.: 14/484,901

(22) Filed: Sep. 12, 2014

Related U.S. Application Data
(63) Continuation of application No. PCT/JP2013/055201, filed on Feb. 27, 2013.

(30) Foreign Application Priority Data
Mar. 15, 2012 (JP) 2012-059168

(51) Int. Cl. B01L 3/00; B29C 53/08; B29C 65/00; B29C 53/38

(52) U.S. Cl. CPC B01L 3/52; B29C 53/382; B29C 53/08; B29C 66/72328; B01L 2300/0809; B01L 2300/126; B29K 2023/04; B29K 2001/00
USPC 422/547; 264/241

(57) ABSTRACT

A reagent container for a biological sample analyzer that has higher impact resistance than a conventional one and a method for manufacturing the reagent container are provided. The reagent container for a biological sample analyzer is formed of a paper sheet member and has a bottom surface and side wall surfaces connected to the bottom surface. The bottom surface is formed by folding one end side of a tubular body with a prismatic tubular shape formed of the sheet member and adhering overlapping surfaces to each other, and the overlapping surfaces are not adhered to each other in a predetermined region including an apex of the bottom surface.

### RELATED APPLICATIONS

This application is a continuation of PCT/JP2013/055201 filed on Feb. 27, 2013, which claims priority to the Japanese Application No. 2012-059168 filed on Mar. 15, 2012. The entire contents of these applications are incorporated herein by reference.

### FIELD OF THE INVENTION

The present invention relates to a reagent container for housing a reagent to be used in an analyzer for analyzing biological samples such as blood and urine collected from humans or animals, and a method for manufacturing the reagent container.

### BACKGROUND OF THE INVENTION

Paper containers, for example, as described in JP H6-345077A and JP 2007-168872A are known as containers for housing liquid.

Such paper containers are formed by applying hot air to a laminated material obtained by laminating thermoplastic resin on both surfaces of a paper substrate and folding the laminated material in which the thermoplastic resin has been melted into a predetermined shape.

Since the reagent container houses chemicals therein, there is a demand to prevent liquid leakage due to breakage of the reagent container during transportation and to transport it safely. However, a paper container is more vulnerable to impact from the outside than a plastic container, and therefore, the paper container may be broken when a large impact is applied thereto, for example, when strong vibration occurs during transportation or when the container is dropped. As disclosed in JP H6-345077A and JP 2007-168872A, the bottoms of many liquid containers have a polygonal shape such as a quadrangle. Therefore, when impact is applied to the bottom surface of the liquid container, stress is concentrated on a corner portion at the lower end of the liquid container, and thereby, for example, a minute opening may be formed near the corner portion and the content may leak therefrom.

### SUMMARY OF THE INVENTION

The scope of the present invention is defined solely by the appended claims, and is not affected to any degree by the statements within this summary.

A first aspect of the present invention is a reagent container that is formed of a paper sheet member and includes a bottom surface and side wall surfaces connected to the bottom surface, in which the bottom surface is formed by folding one end side of a tubular body with a prismatic tubular shape formed of the sheet member and adhering overlapping surfaces to each other, and the overlapping surfaces are not adhered to each other in a predetermined region including an apex of the bottom surface.

A second aspect of the present invention is a method for manufacturing a reagent container from a sheet member including a paper substrate layer and a thermoplastic resin layer, the method including steps of forming a tubular body that has a quadrangular cross-section using the sheet member, melting the thermoplastic resin layer at a region other than a portion that becomes a corner portion of a bottom surface of the reagent container on one end side of the tubular body, and forming the bottom surface by folding the one end side of the tubular body and welding the thermoplastic resin layers of overlapping surfaces.

### BRIEF DESCRIPTION OF THE DRAWINGS

FIG. 1 is a perspective view of the exterior of a reagent container according to an embodiment.

FIG. 2 is a perspective view of the exterior of the reagent container according to the embodiment.

FIG. 3 is a perspective view illustrating a usage state of the reagent container according to the embodiment.

FIG. 4 is a cross-sectional view illustrating a configuration of a sheet member.

FIG. 5 is a developed view of the reagent container according to the embodiment.

FIG. 6 is a perspective view illustrating a configuration of a tubular carton.

FIG. 7 is a schematic view illustrating molten portions of a carton bottom portion.

FIG. 8 is a drawing illustrating another example of a shape of the molten portion.

FIG. 9 is a drawing illustrating a step of folding the carton bottom portion.

FIG. 10 is a perspective view of a bottom surface of the reagent container according to the embodiment.

FIG. 11 is a bottom view of the reagent container according to the embodiment.

FIG. 12 is a cross-sectional arrow view taken along A-A line of FIG. 11, illustrating a cross-section of the bottom surface.

### DETAILED DESCRIPTION OF THE PREFERRED EMBODIMENTS

Hereinafter, a preferred embodiment of the present invention will be described with reference to the drawings.

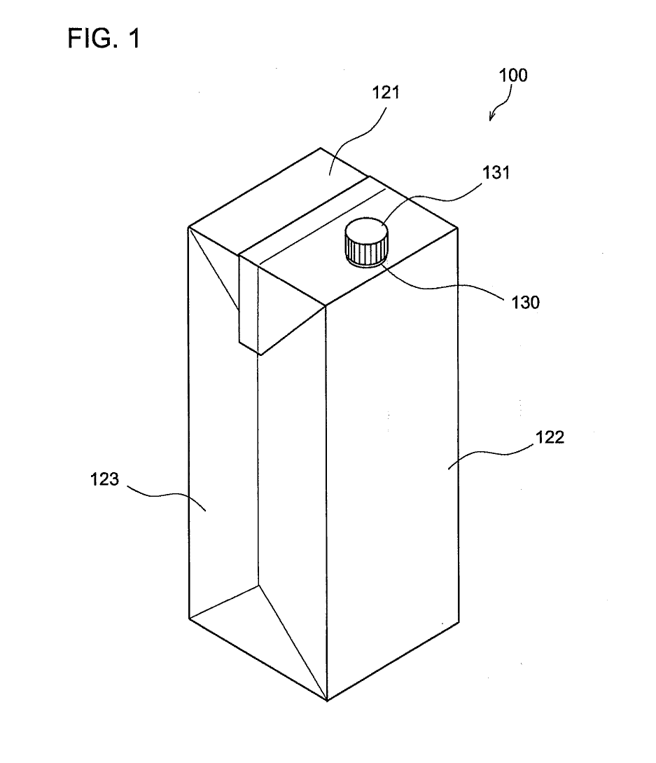

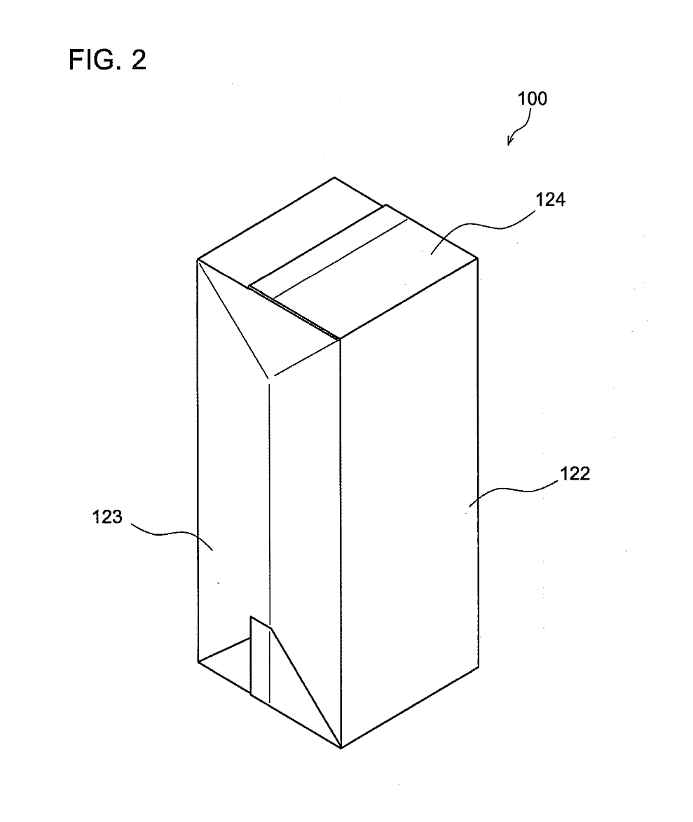

The reagent container according to this embodiment is a reagent container for housing a reagent to be used to analyze biological samples. FIGS. 1 and 2 are perspective views of the exterior of a reagent container 100. The reagent container 100 is constituted by a sheet member obtained by coating both surfaces of paper with polyethylene. The reagent container 100 has a rectangular parallelepiped shape with a square bottom surface, and its volume is 4 liters. Also, the reagent container 100 is used to house a hemolyzing agent or a diluting solution that is used when analyzing blood. The hemolyzing agent is a reagent for hemolyzing erythrocytes and contains a surfactant. A nonionic surfactant or an anionic surfactant is used as the surfactant. It should be noted that a cationic surfactant may be used in addition to the nonionic surfactant or the anionic surfactant. The diluting solution is a reagent used to dilute blood as well as to wash a channel of a measurement unit 2 of a biological sample analyzer 1, and also contains a surfactant. It should be noted that in this embodiment, the reagent container 100 houses the hemolyzing agent.

As shown in the drawings, the reagent container 100 has an upper surface 121, a front surface 122, side surfaces 123, a back surface (not shown) and a bottom surface 124. The upper surface 121 of the reagent container 100 is provided with an opening 130, and the opening 130 of the reagent container 100 before being unsealed is sealed by a cap 131.

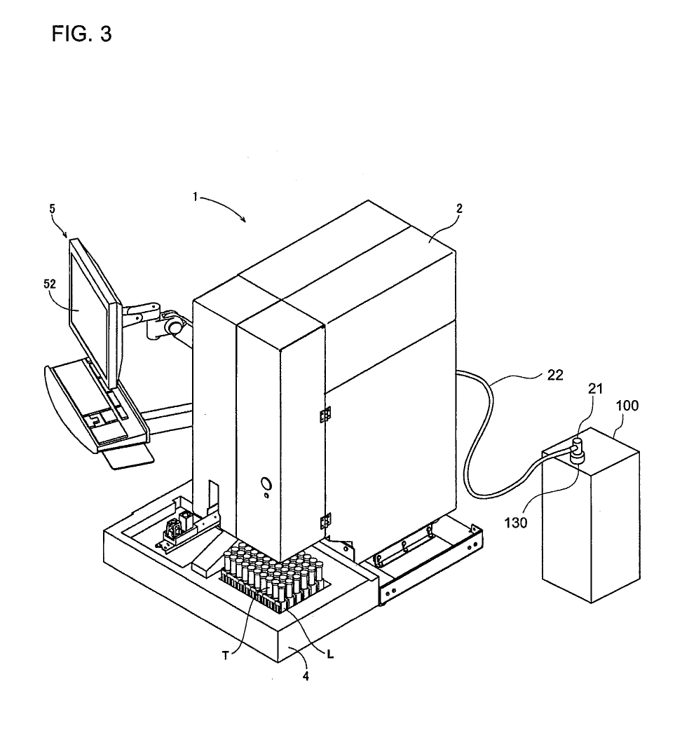

FIG. 3 is a perspective view illustrating a usage state of the reagent container 100. As shown in FIG. 3, to be used, the reagent container 100 is connected to the biological sample analyzer 1. The biological sample analyzer 1 is a multiple-item hemocyte analyzer for detecting leukocytes, erythrocytes, platelets, and the like, which are contained in a blood sample, and for counting each type of the hemocytes. As shown in FIG. 3, the biological sample analyzer 1 includes the measurement unit 2, a transporting unit 4 disposed on the front surface side with respect to the measurement unit 2, and an information processing unit 5 that can control the measurement unit 2 and the transporting unit 4.

The transporting unit 4 transports a specimen rack L housing a plurality of sample containers T. A sample container T has a tubular shape and houses a blood sample collected from a patient therein. The measurement unit 2 sucks a blood sample from a sample container T housed in the specimen rack L that has been transported by the transporting unit 4, and measures the blood sample.

The measurement unit 2 can measure leukocytes, nucleated erythrocytes, and the like contained in the blood sample by flow cytometry with a semiconductor laser. In the flow cytometry, the measurement sample is caused to pass through a flow cell in the state where the measurement sample is surrounded by a sheath liquid flow. When the measurement sample passes through the flow cell, electrical or optical information is detected and the hemocytes contained in the blood sample are classified and counted based on the detection data. The measurement unit 2 uses the reagent (hemolyzing agent) housed in the reagent container 100 when measuring the blood sample. That is, in order to break the cell membranes of the erythrocytes contained in the blood sample when detecting the leukocytes, for example, the hemolyzing agent is mixed into the blood sample and then this mixture (measurement sample) is subjected to the measurement. It should be noted that the reagent container 100 may be used to house the diluting solution that is used as the sheath liquid for surrounding the measurement sample in a flow cell. The measurement data produced as a result of measuring the measurement samples are transmitted to the information processing unit 5 constituted by a computer, and then the information processing unit 5 analyzes the measurement data to provide the final results of the analysis. The obtained results of the analysis is displayed in a display portion 52 provided in the information processing unit 5.

A connector 21 of the biological sample analyzer 1 is connected to the opening 130 of the reagent container 100 in a state where the cap 131 is removed therefrom. The connector 21 is connected to one end of a tube 22 and the other end of the tube 22 is connected to the measurement unit 2. Moreover, the connector 21 has a suction tube (not shown) extending downward inside the reagent container 100, and the suction tube is inserted through the opening 130 when the connector 21 is attached to the reagent container 100. While the biological sample analyzer 1 is used, the reagent inside the reagent container 100 is supplied to the measurement unit 2 through the suction tube inside the reagent container 100, the connector 21 and the tube 22. A suction tube and a connector that have a configuration, for example, disclosed in JP H9-297146A or US 2005/0191211A1 can be used as such a suction tube and the connector 21. Once the connector 21 is connected to the opening 130 in order to use the biological sample analyzer 1, by the next time the reagent container 100 is replaced by a new one after the reagent inside the reagent container 100 is consumed, the reagent container 100 is used in a state where the connector 21 is connected to the opening 130.

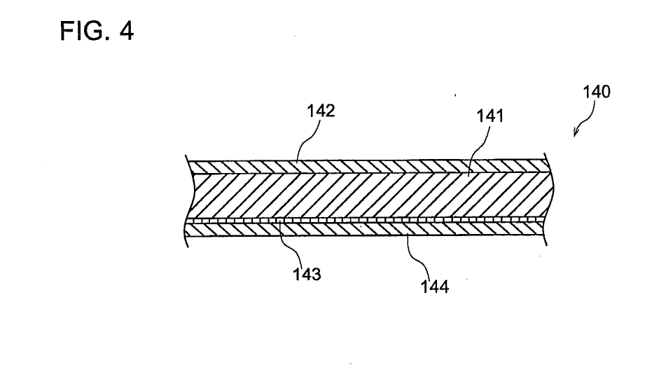

Next, a method for manufacturing the reagent container 100 will be described. The reagent container 100 is formed by folding the sheet member. FIG. 4 is a cross-sectional view illustrating a configuration of the sheet member. A sheet member 140 has a multilayer structure. The sheet member 140 includes a substrate layer 141 made of a sheet of paper, a polyethylene layer 142 provided on one surface of the substrate layer 141, and a barrier layer 143 and a polyethylene layer 144 provided on the other surface of the substrate layer 141. The polyethylene layers 142 and 144 perform the function of preventing the reagent from infiltrating through the substrate layer 141 and leaking out of the reagent container 100, and, in addition, the polyethylene layers 142 and 144 are melted by being heated and are used to weld the folded sheet member. The barrier layer 143 is provided between the substrate layer 141 and the polyethylene layer 144, and formed of silicon oxide by ceramic vapor deposition. It should be noted that aluminum oxide, magnesium oxide, titanium oxide, silicon nitride, zirconium oxide, diamondlike carbon, or the like may be used as the material instead of silicon oxide. The barrier layer 143 performs the function of preventing the reagent from being deteriorated due to oxygen, water vapor, or the like infiltrating the reagent container 100. The surface (referred to as “back side” hereinafter) on the side where the barrier layer 143 is formed with respect to the substrate layer 141 is an inner surface of the reagent container 100, and the surface (referred to as “front side” hereinafter) on the side where the barrier layer 143 is not formed with respect to the substrate layer 141 is an outer surface of the reagent container 100.

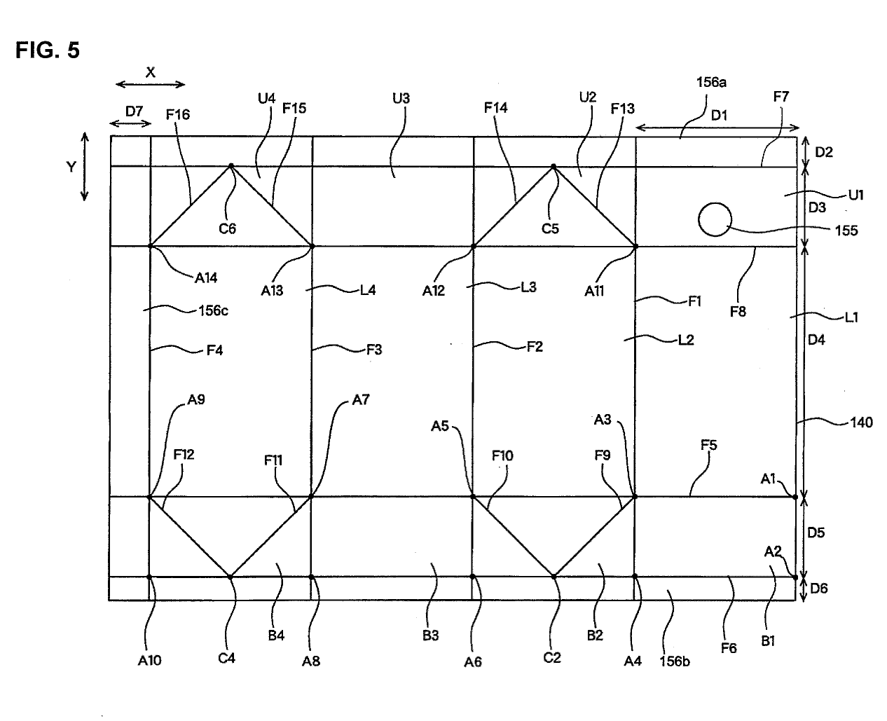

FIG. 5 is a developed view of the reagent container 100. The sheet member 140 is formed into substantially a rectangular sheet. The sheet member 140 is provided with folds F1 to F16 to be used to fold the sheet member 140 to form the reagent container 100. The folds F1 to F4 are bend lines that are in the form of a straight line and are parallel to each other. Moreover, the folds F5 to F8 are bend lines that are in the form of a straight line and are orthogonal to the folds F1 to F4. Each of the folds F1 to F4 intersects the folds F5 to F8.

Moreover, the sheet member 140 is divided into a plurality of rectangular portions by the folds F1 to F8. Specifically, the sheet member 140 has rectangular portions U1, U2, U3 and U4 that constitute the upper surface of the reagent container 100, rectangular portions L1, L2, L3 and L4 that constitute the front surface, the side surfaces and the back surface of the reagent container 100, and rectangular portions B1, B2, B3 and B4 that constitute the bottom surface of the reagent container 100. In addition, the rectangular portion U1, which is one of the rectangular portions constituting the upper surface, is provided with a circular hole 155 for constituting the opening 130. Hereinafter, in the description of the sheet member 140, the side where the rectangular portions U1, U2, U3 and U4 that constitute the upper surface are provided is an upper side, the side where the rectangular portions B1, B2, B3 and B4 that constitute the bottom surface are provided is a lower side, the side where the rectangular portion L1 that constitutes the front surface is provided is a right side, and the side where the rectangular portion L4 that constitutes the side surface is provided is a left side.

The rectangular portion B2 is provided with a fold F9 in the form of a straight line that joins an upper right apex A3 of the rectangular portion B2 (that is, the intersection of the fold F1 and the fold F5) and a middle point C2 of the lower side of the rectangular portion B2. In addition, the rectangular portion B2 is provided with a fold F10 in the form of a straight line that joins an upper left apex A5 of the rectangular portion B2 (that is, the intersection of the fold F2 and the fold F5) and a middle point C2 of the lower side of the rectangular portion B2.

In the same manner, the rectangular portion B4 is provided with a fold F11 in the form of a straight line that joins an upper right apex A7 of the rectangular portion B4 (that is, the intersection of the fold F3 and the fold F5) and a middle point C4 of the lower side of the rectangular portion B4, and a fold F12 in the form of a straight line that joins an upper left apex A9 of the rectangular portion B4 (that is, the intersection of the fold F4 and the fold F5) and a middle point C4 of the lower side of the rectangular portion B4. These folds F9 to F12 are provided in order to form the bottom surface 124.

The rectangular portion U2 is provided with a fold F 13 in the form of a straight line that joins a lower right apex A11 of the rectangular portion U2 (that is, the intersection of the fold F1 and the fold F8) and a middle point C5 of the upper side of the rectangular portion U2, and a fold F14 in the form of a straight line that joins a lower left apex A12 of the rectangular portion U2 (that is, the intersection of the fold F2 and the fold F8) and a middle point C5 of the upper side of the rectangular portion U2. In the same manner, the rectangular portion U4 is provided with a fold F15 in the form of a straight line that joins a lower right apex A13 of the rectangular portion U4 (that is, the intersection of the fold F3 and the fold F8) and a middle point C6 of the upper side of the rectangular portion U4, and a fold F16 in the form of a straight line that joins a lower left apex A14 of the rectangular portion U4 (that is, the intersection of the fold F4 and the fold F8) and a middle point C6 of the upper side of the rectangular portion U4. These folds F13 to F16 are provided in order to form the upper surface 121.

A rectangular portion 156a having a belt shape is provided at the upper end of the sheet member 140. In the same manner, a rectangular portion 156b having a belt shape is provided at the lower end of the sheet member 140. These rectangular portions 156a and 156b serve as an extension portion for preventing liquid leakage when the sheet member 140 is folded to form the reagent container 100.

A rectangular portion 156c having a belt shape is provided at the left end of the sheet member 140. This rectangular portion 156c serves as a welding portion when a tubular body having a quadrangular cross-section is formed from the sheet member 140.

A length D1 of the rectangular portions U1, U2, U3 and U4 in a longitudinal direction (in a direction of X in FIG. 5) is 140 mm. In addition, a length D2 of the rectangular portion 156a in a short direction (in a direction of Y in FIG. 5) is 25 mm, a length D3 of the rectangular portions U1, U2, U3 and U4 in a short direction (in a direction of Y in FIG. 5) is 70.5 mm, a length D4 of the rectangular portions L1, L2, L3 and L4 in a longitudinal direction (in a direction of Y in FIG. 5) is 225 mm, a length D5 of the rectangular portions B1, B2, B3 and B4 in a short direction (in a direction of Y in FIG. 5) is 74.5 mm, and a length D6 of the rectangular portion 156b in a short direction (in a direction of Y in FIG. 5) is 20 mm. Moreover, a length D7 of the rectangular portion 156c in a short direction (in a direction of X in FIG. 5) is 37 mm.

Steps of manufacturing the reagent container 100 will be described. First, the rectangular portion 156c on the front side of the sheet member 140 is heated by hot air. Thereby, the polyethylene layer 142 of the rectangular portion 156c is melted. The sheet member 140 is folded upward along the four folds F1, F2, F3 and F4 in a vertical direction and is formed into a tubular shape having a quadrangular cross-section. At that time, the front side of the rectangular portion 156c comes into close contact with the back side at the right end of the sheet member 140, and the rectangular portion 156c and the right end portion of the sheet member 140 are welded by solidifying the molten polyethylene layer 142. In this manner, a tubular body having a quadrangular cross-section (referred to as “tubular carton” hereinafter) is formed.

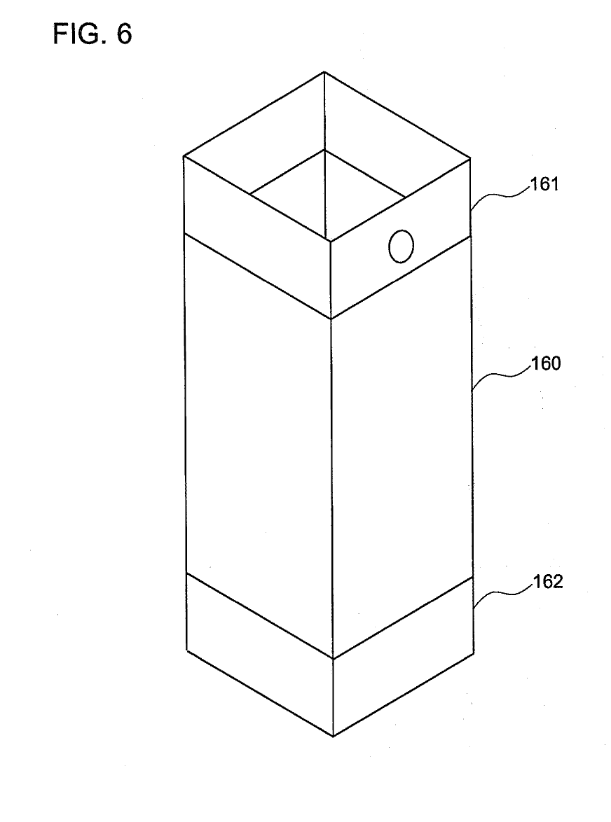

FIG. 6 is a perspective view illustrating a configuration of the tubular carton. A tubular carton 160 has a tubular shape having a quadrangular cross-section with its upper and lower ends being open. The tubular carton 160 has a carton top portion 161 constituted by the rectangular portions U1, U2, U3 and U4 that are provided on the upper end side and a carton bottom portion 162 constituted by the rectangular portions B1, B2, B3 and B4 that are provided on the lower end side.

After the tubular carton 160 is formed, the process proceeds to a step of forming the bottom surface 124 (see FIG. 2) of the reagent container 100. In the step of forming the bottom surface 124 of the reagent container 100, a mandrel having a quadrangular prism shape is inserted into the tubular carton 160. At that time, the mandrel is inserted from above the tubular carton 160, and the lower end portion of the tubular carton 160, that is, the end portion on the side of the carton bottom portion 162 is open.

Hot air from a hot air nozzle is applied only to trapezoidal portions 171 to 178, which will be described later, in the inner surface of the carton bottom portion 162 in this state, so that the polyethylene layers 142 and 144 of the trapezoidal portions 171 to 178 are melted. Thereby, molten portions are formed in the trapezoidal portions 171 to 178 of the carton bottom portion 162.

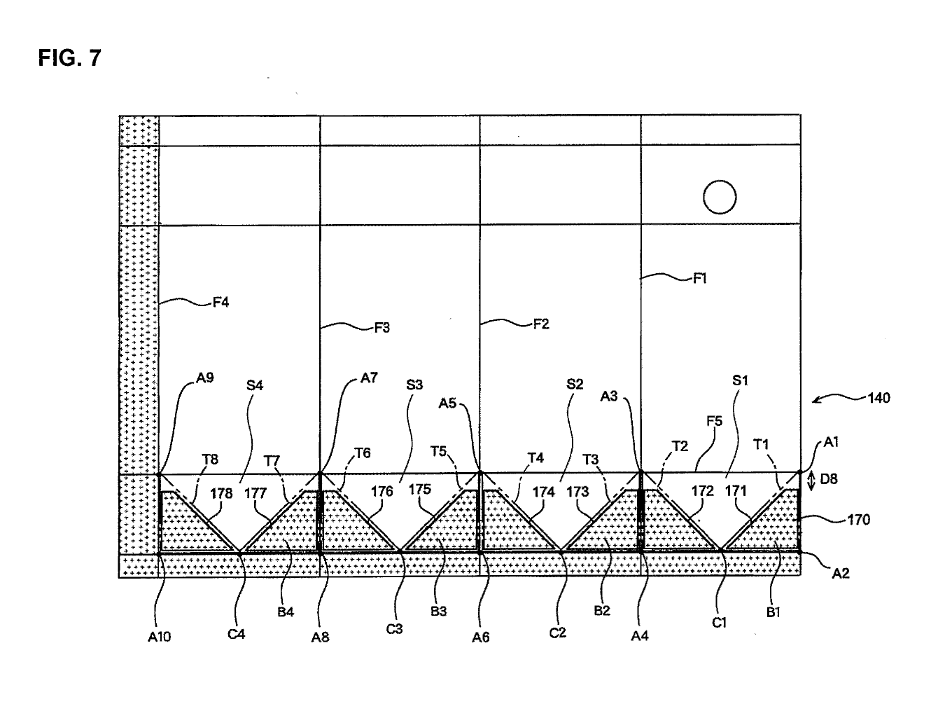

FIG. 7 is a schematic view illustrating the molten portions of the carton bottom portion 162. A molten portion 170 in which a plurality of trapezoidal portions 171 to 178 are located in a row is formed in the carton bottom portion 162. The rectangular portion B1 included in the carton bottom portion 162 is provided with two trapezoidal portions 171 and 172, the rectangular portion B2 is provided with two trapezoidal portions 173 and 174, the rectangular portion B3 is provided with two trapezoidal portions 175 and 176, and the rectangular portion B4 is provided with two trapezoidal portions 177 and 178. Hereinafter, the trapezoidal portions 171 to 178 will be described.

As shown in FIG. 7, the rectangular portion B1 has apexes A1, A2, A3 and A4 at its four corners. The rectangular portion B2 has apexes A3, A4, A5 and A6 at its four corners. This rectangular portion B2 is adjacent to the rectangular portion B1 and shares the apexes A3 and A4 with the rectangular portion B1. Moreover, the rectangular portion B3 has apexes A5, A6, A7 and A8 at its four corners, and the rectangular portion B4 has apexes A7, A8, A9 and A10 at its four corners. The rectangular portion B3 is adjacent to the rectangular portion B2 and the rectangular portion B4, and shares the apexes A5 and A6 with the rectangular portion B2 and the apexes A7 and A8 with the rectangular portion B4.

As shown in FIG. 7, it is assumed that two small triangles T1 and T2 and a large triangle S1 are located in the rectangular portion B1. The small triangle T1 has, as its apexes, the apex A1 at the upper right corner of the rectangular portion B1, the apex A2 at the lower right corner of the rectangular portion B1 and a middle point C1 of the lower side of the rectangular portion Bl. That is, the small triangle T1 has, as its sides, the right side of the rectangular portion B1, the right half of the lower side of the rectangular portion B1 and a line segment joining the apex A1 and the middle point C1. In addition, the angle of the apex A2 is a right angle, and the two sides extending from the apex A2 (the right side of the rectangular portion B1 and the right half of the lower side of the rectangular portion B1) have the same length. That is, the small triangle T1 is an isosceles right triangle.

In the same manner, the small triangle T2 has, as its apexes, the apex A3 at the upper left corner of the rectangular portion B1, the apex A4 at the lower left corner of the rectangular portion B1 and a middle point C1 of the lower side of the rectangular portion B1. That is, the small triangle T2 has, as its sides, the left side of the rectangular portion B1, the left half of the lower side of the rectangular portion B1 and a line segment joining the apex A3 and the middle point C1. The small triangle T2 is also an isosceles right triangle, in which the angle of the apex A4 is a right angle and the two sides extending from the apex A4 (the left side of the rectangular portion B1 and the left half of the lower side of the rectangular portion B1) have the same length. Moreover, the rectangular portion B1 is a rectangle, and therefore, the small triangles T1 and T2 have axially symmetrical shapes with respect to the symmetry axis extending from the middle point C1 in parallel with the left and right sides of the rectangular portion B1. The large triangle S1 is an isosceles right triangle that has, as its apexes, the apexes A1 and A3 of the rectangular portion B1 and the middle point C1.

In the same manner, it is assumed that small triangles T3 and T4 and a large triangle S2 are located in the rectangular portion B2, small triangles T5 and T6 and a large triangle S3 are located in the rectangular portion B3, and small triangles T7 and T8 and a large triangle S4 are located in the rectangular portion B4. The small triangle T3 has, as its apexes, the apex A3 at the upper right corner of the rectangular portion B2, the apex A4 at the lower right corner of the rectangular portion B2 and a middle point C2 of the lower side of the rectangular portion B2. Here, the rectangular portions B1, B2, B3 and B4 are congruent with each other. Accordingly, the small triangle T3 is an isosceles right triangle congruent with the small triangle T1. The small triangle T4 has, as its apexes, the apex A5 at the upper left corner of the rectangular portion B2, the apex A6 at the lower left corner of the rectangular portion B2 and a middle point C2 of the lower side of the rectangular portion B2. This small triangle T4 is an isosceles right triangle congruent with the small triangle T2.

The small triangle T5 has, as its apexes, the apex A5 at the upper right corner of the rectangular portion B3, the apex A6 at the lower right corner of the rectangular portion B3 and a middle point C3 of the lower side of the rectangular portion B3. Moreover, the small triangle T7 has, as its apexes, the apex A7 at the upper right corner of the rectangular portion B4, the apex A8 at the lower right corner of the rectangular portion B4 and a middle point C4 of the lower side of the rectangular portion B4. These small triangles T5 and T7 are congruent with the small triangle T1.

The small triangle T6 has, as its apexes, the apex A7 at the upper left corner of the rectangular portion B3, the apex A8 at the lower left corner of the rectangular portion B3 and a middle point C3 of the lower side of the rectangular portion B3. Moreover, the small triangle T8 has, as its apexes, the apex A9 at the upper left corner of the rectangular portion B4, the apex A10 at the lower left corner of the rectangular portion B4 and a middle point C4 of the lower side of the rectangular portion B4. These small triangles T6 and T8 are congruent with the small triangle T2. It should be noted that the large triangles S2 to 4 are congruent with the large triangle S1.

The small triangle T2 and the small triangle T3 share the side joining the apex A3 and the apex A4. This side joining the apex A3 and the apex A4 is located on the fold F1. Moreover, the small triangles T2 and T3 have axially symmetrical shapes with respect to the fold F1 as the symmetry axis. In the same manner, the small triangle T4 and the small triangle T5 share the side joining the apex AS and the apex A6. This side joining the apex A5 and the apex A6 is located on the fold F2. These small triangles T4 and T5 have axially symmetrical shapes with respect to the fold F2 as the symmetry axis. The small triangle T6 and the small triangle T7 share the side joining the apex A7 and the apex A8. This side joining the apex A7 and the apex A8 is located on the fold F3. These small triangles T6 and T7 have axially symmetrical shapes with respect to the fold F3 as the symmetry axis.

The trapezoidal portion 171 has a trapezoidal shape in which a portion including the apex A1 of the small triangle T1 is removed. That is, the trapezoidal portion 171 has an upper edge formed by removing a portion including the apex A1 of the small triangle T1, a lower edge which is a line segment joining the apexes A2 and C1, a side extending from the apex A2 to the right end of the upper edge, and a side extending from the apex C1 to the left end of the upper edge.

The trapezoidal portion 172 has a trapezoidal shape in which a portion including the apex A3 of the small triangle T2 is removed. That is, the trapezoidal portion 172 has an upper edge formed by removing a portion including the apex A3 of the small triangle T2, a lower edge which is a line segment joining the apexes A4 and C1, a side extending from the apex A4 to the left end of the upper edge, and a side extending from the apex C1 to the right end of the upper edge.

In the same manner, the trapezoidal portion 173 has a trapezoidal shape in which a portion including the apex A3 of the small triangle T3 is removed, the trapezoidal portion 174 has a trapezoidal shape in which a portion including the apex A5 of the small triangle T4 is removed, the trapezoidal portion 175 has a trapezoidal shape in which a portion including the apex A5 of the small triangle T5 is removed, the trapezoidal portion 176 has a trapezoidal shape in which a portion including the apex A7 of the small triangle T6 is removed, the trapezoidal portion 177 has a trapezoidal shape in which a portion including the apex A7 of the small triangle T7 is removed, and the trapezoidal portion 178 has a trapezoidal shape in which a portion including the apex A9 of the small triangle T8 is removed.

The trapezoidal portion 172 and the trapezoidal portion 173 share one side that is located on the fold F1. That is, the trapezoidal portion 172 and the trapezoidal portion 173 have axially symmetrical shapes with respect to the fold F1 as the symmetry axis. In the same manner, the trapezoidal portion 174 and the trapezoidal portion 175 share one side that is located on the fold F2 and have axially symmetrical shapes with respect to the fold F2 as the symmetry axis. The trapezoidal portion 176 and the trapezoidal portion 177 share one side that is located on the fold F3 and have axially symmetrical shapes with respect to the fold F3 as the symmetry axis.

In other words, the trapezoidal portion 171 included in the molten portion 170 has the same shape as the above-described small triangle T1, except that the apex A1 and its surroundings are removed. Also, the trapezoidal portion 172 has the same shape as the above-described small triangle T2, except that the apex A3 and its surroundings are removed. In the same manner, the trapezoidal portions 173 to 178 have the same shape as the small triangles T3 to T8, respectively, except that the apexes A3, A5 and A7, and their surroundings are removed. It should be noted that the trapezoidal portion 171 is provided in the region spaced apart by a length D8 (10 mm) from the apex A1, and the trapezoidal portion 172 is provided in the region spaced apart by the same length D8 (10 mm) from the apex A3. The other trapezoidal portions 173 to 178 are similarly provided.

Moreover, as shown in FIG. 5, the folds F9 and F10 are provided so as to join the two apexes A3 and A5 at the upper end of the rectangular portion B2 and the middle point C2 of the lower side of the rectangular portion B2. In the same manner, the folds F11 and F12 are provided so as to join the two apexes A7 and A9 at the upper end of the rectangular portion B4 and the middle point C4 of the lower side of the rectangular portion B4. That is, in the rectangular portion B2, the folds F9 and F10 are provided along an oblique side of the above-described small triangle T3 and an oblique side of the above-described small triangle T4. In the same manner, in the rectangular portion B4, the folds F11 and F12 are provided along an oblique side of the small triangle T5 and an oblique side of the small triangle T6.

Hot air from a hot air nozzle is applied only to the trapezoidal portions 171 to 178 in the inner surface of the carton bottom portion 162. That is, hot air is applied to the trapezoidal portions 171 to 178 in the inner surface of the carton bottom portion 162, and is not applied to the other portions. Therefore, the polyethylene layer 144 and the polyethylene layer 142 are melted in the trapezoidal portions 171 to 178.

It should be noted that in FIG. 7, it is shown that the adjacent two trapezoidal portions 172 and 173, 174 and 175, and 176 and 177 are away from each other, but, actually, the trapezoidal portions 172 and 173, 174 and 175, and 176 and 177 are not away from each other, and a continuous region is formed. That is, the trapezoidal portions 172 and 173 are formed into one trapezoid, the trapezoidal portions 174 and 175 are formed into one trapezoid, and the trapezoidal portions 176 and 177 are formed into one trapezoid.

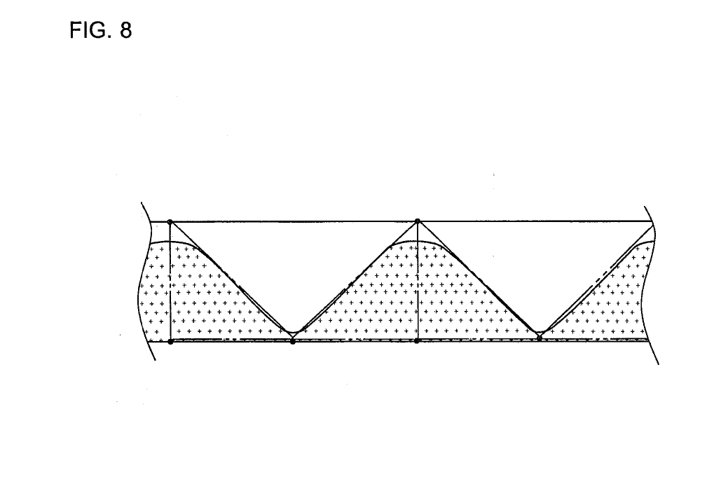

It should be noted that in this embodiment, the configuration in which each of the trapezoidal portions 171 to 178 has a trapezoidal shape having an upper edge in the form of a straight line is adopted, but there is no limitation to this configuration. FIG. 8 is a drawing illustrating another example of a shape of the molten portion. The trapezoidal portions 171 to 178 need not have the upper edge portions in the form of a straight line and may have a shape in which the upper end portion is curved so as to be a circular arc as shown in FIG. 8. Moreover, the trapezoidal portions 171 to 177 need not have an apex with an acute angle in the same manner as in a trapezoid and may have corner portions in a rounded shape, or in a portion in which two trapezoidal portions, such as the trapezoidal portions 171 and 172, are connected via one apex, the two trapezoidal portions may be connected so as to have a certain width as shown in FIG. 8.

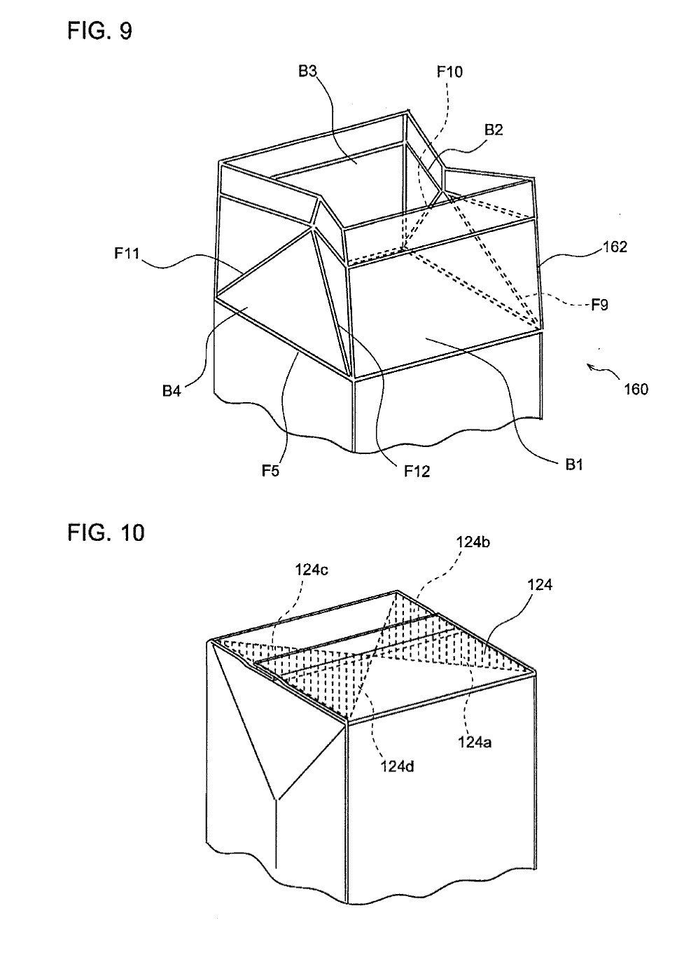

Next, the process proceeds to a step of folding the carton bottom portion 162. In this step, the carton bottom portion 162 is folded along the folds by a folding device (not shown). FIG. 9 is a drawing illustrating a step of folding the carton bottom portion 162. As shown in the drawing, the tubular carton 160 is folded upward along the fold F5 at the upper end of the rectangular portions B1, B2, B3 and B4, and the rectangular portions B2 and B4 are simultaneously folded downward along the oblique folds F9, F10, F11 and F12.

As a result, on the back side of the sheet member 140 (on the surface on the side where the polyethylene layer 144 is formed), the trapezoidal portion 173 of the rectangular portion B2 comes into close contact with the trapezoidal portion 172 of the rectangular portion B1, and the trapezoidal portion 174 of the rectangular portion B2 comes into close contact with the trapezoidal portion 175 of the rectangular portion B3. In the same manner, the trapezoidal portion 177 of the rectangular portion B4 comes into close contact with the trapezoidal portion 176 of the rectangular portion B3, and the trapezoidal portion 178 of the rectangular portion B4 comes into close contact with the trapezoidal portion 171 of the rectangular portion B1. That is, the small triangle T3 of the rectangular portion B2 overlaps the small triangle T2 of the rectangular portion B1, and the small triangle T4 of the rectangular portion B2 overlaps the small triangle T5 of the rectangular portion B3. In the same manner, the small triangle T7 of the rectangular portion B4 overlaps the small triangle T6 of the rectangular portion B3, and the small triangle T8 of the rectangular portion B4 overlaps the small triangle T1 of the rectangular portion B1.

When pressure is applied to the carton bottom portion 162 in a state where the carton bottom portion 162 is folded in this manner, on the front side of the sheet member 140 (on the surface on the side where the polyethylene layer 142 is formed), the small triangle T3 and the small triangle T4 of the rectangular portion B2 come into close contact with the large triangle S2, and the small triangle T7 and the small triangle T8 of the rectangular portion B4 come into close contact with the large triangle S4. Thereby, the bottom surface 124 is formed. FIG. 10 is a perspective view of the bottom surface 124 after being formed. On the back side of the sheet member 140, as a result of the small triangle T3 of the rectangular portion B2 overlapping the small triangle T2 of the rectangular portion B1, a triangular overlapping portion 124a is formed in which the two sheet portions overlap each other. Moreover, on the back side of the sheet member 140, as a result of the small triangle T4 of the rectangular portion B2 overlapping the small triangle T5 of the rectangular portion B3, a triangular overlapping portion 124b is formed in which the two sheet portions overlap each other. In the same manner, as a result of the small triangle T7 of the rectangular portion B4 overlapping the small triangle T6 of the rectangular portion B3, an overlapping portion 124c is formed, and as a result of the small triangle T8 of the rectangular portion B4 overlapping the small triangle T1 of the rectangular portion B1, an overlapping portion 124d is formed.

Next, the process proceeds to a step of cooling the bottom surface 124. In this step, the bottom surface 124 is cooled by a cooling device. In the overlapping portions 124a, 124b, 124c and 124d, the polyethylene layers 144 of the two sheet portions, which have been melted, are in close contact with each other. By cooling the bottom surface 124, the molten polyethylene layers 144 are solidified to weld the sheet portions of the overlapping portions 124a, 124b, 124c and 124d. It should be noted that also on the front side of the sheet member 140 of the carton bottom portion 162, the polyethylene layers 142 of the two sheet portions, which have been melted, are in close contact with each other, and by cooling the bottom surface 124, these two sheet portions are welded. Thereby, the bottom surface 124 is completed.

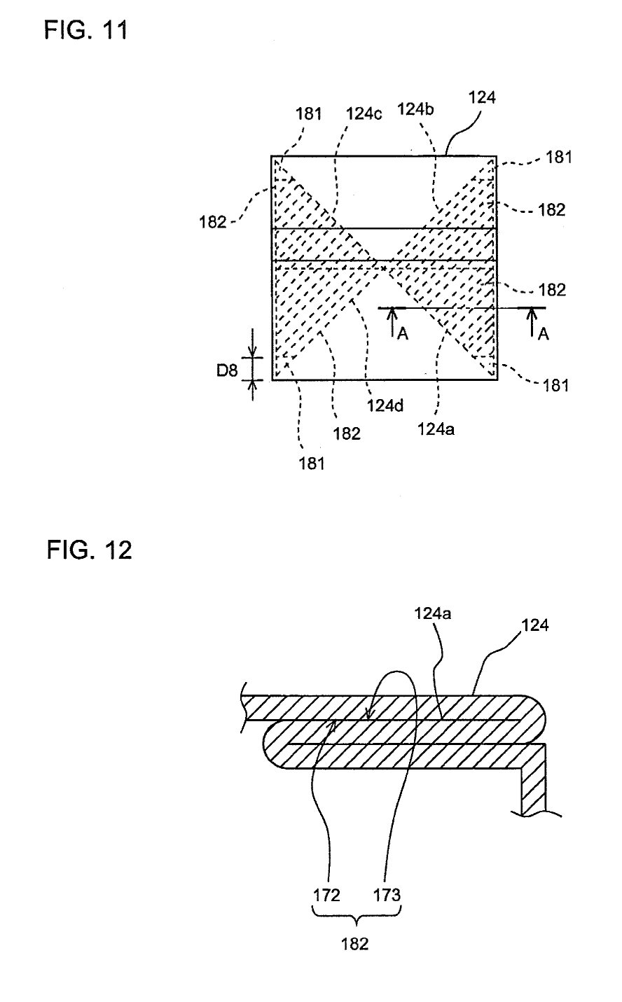

FIG. 11 is a bottom view of the reagent container 100. As shown in FIG. 11, the overlapping portions 124a, 124b, 124c and 124d that have been formed in this manner are provided with non-adhered portions 181 including an apex of the quadrangular bottom surface 124 and adhered portions 182 that are portions other than the non-adhered portions 181. That is, the non-adhered portion 181 is a portion in which the polyethylene layer 144 has not been melted without applying hot air thereto, and therefore, the two sheet portions are not welded. On the other hand, the adhered portion 182 is a portion in which the polyethylene layer 144 has been melted by applying hot air thereto, and therefore, the two overlapping sheet portions are welded. The non-adhered portion 181 of the overlapping portion 124a is a triangle similar to the overlapping portion 124a, and is a region with a triangular shape having the apex at the position that is spaced apart by the length D8 (10 mm) from the apex of the bottom surface 124 in a direction toward the apex of the overlapping portion 124b. Since the other non-adhered portions 181 are also provided in the similar region, the description about them will be omitted. It should be noted that although a shape of the non-adhered portion 181 is not limited to a triangle, it is preferable that the non-adhered portion 181 includes at least a region in a range of 5 to 15 mm from the apex included in the non-adhered portion 181 (that is, a region in a shape of an arc that has the apex as the center and a radius of 5 to 15 mm).

FIG. 12 is a cross-sectional arrow view taken along A-A line of FIG. 11, illustrating a cross-section of the bottom surface 124. As shown in FIG. 12, the bottom surface 124 is formed by folding the sheet member 140. The overlapping portion 124a of the bottom surface 124 is constituted by the small triangles T2 and T3 that overlap each other by folding the sheet member 140. Moreover, in the overlapping portion 124a, the trapezoidal portion 173 and the trapezoidal portion 172 overlap and adhere to each other, and thereby the adhered portion 182 is formed.

By adopting the above-described configuration, the non-adhered portion 181 of the bottom surface 124 is deformed when impact is applied to the corner portion of the bottom surface 124 of the reagent container 100, and thereby, it is possible to distribute stress generated at the corner portion of the bottom surface 124 and to prevent the corner portion and its surroundings from being broken. Moreover, in the reagent container 100, it is possible to prevent the reagent container from being broken only by not welding the non-adhered portion 181, and therefore, it is possible to enhance the impact resistance without providing a reinforcing member at the lower end of the reagent container 100.

If the region including the apex of the bottom surface of the reagent container is welded by resin, the corner portion itself can maintain its shape when impact is applied to the corner portion of the bottom surface, but there is a possibility that the impact acts on the end portion of resin welded portion and the polyethylene layer and the barrier layer are damaged at the border between the welded portion and the non-welded portion. If the polyethylene layer is damaged, the reagent may pass through the damaged portion of the polyethylene layer and an opening may be formed in the substrate layer paper by erosive action of the surfactant contained in the reagent, and thereby, the liquid may leak therefrom. Also, if the barrier layer is damaged, there is a possibility that air or water vapor infiltrates from the outside of the reagent container and thereby, the deterioration of the reagent progresses.

In the reagent container 100 according to the above-described embodiment, the non-adhered portions are provided at the corner portions of the bottom surface 124, and therefore, the corner portion itself can be deformed to absorb impact when impact is applied to the corner portion, and it is possible to prevent the barrier layer and the polyethylene layer near the corner portion from being damaged. Therefore, even when the reagent containing a nonionic surfactant or an anionic surfactant, which especially exhibits strong osmotic action, is housed, it can be expected that the reagent container is highly effective in preventing liquid leakage.

### Other Embodiments

In the above-described embodiment, as shown in FIG. 11, the non-adhered portion 181 is a region with a triangular shape having the apex at the position that is spaced apart by the length D8 (10 mm) from the apex of the bottom surface 124, but the length D8 is not limited to 10 mm. When using the reagent container 100 according to the above-described embodiment, it is possible to enhance the impact resistance of the corner portion as long as D8 is 5 mm or more and 15 mm or less. Moreover, the length D8 can be set as appropriate in accordance with the size of the reagent container, and it is possible to enhance the impact resistance of the corner portion as long as the length D8 is longer than or equal to 3% with respect to the length D1 of one side of the bottom surface 124. In particular, when the length D8 is 3% or more and 18% or less with respect to the length D1, it is possible to enhance the impact resistance near the corner portion while shape stability of the reagent container 100 is preferably maintained.

It should be noted that in the above-described embodiment, the configuration has been described in which the reagent container 100 has a rectangular parallelepiped shape with a square cross-section, but there is no limitation to this. The reagent container may have a rectangular parallelepiped shape with a rectangular cross-section or have a cross-section in another polygonal shape.

In the above-described embodiment, the configuration has been described in which the polyethylene layer of the sheet member 140 is heated by hot air to be melted and the surfaces of the sheet member 140 in which the polyethylene layer is melted come into close contact with each other to be welded, but there is no limitation to this. A configuration may be adopted in which the surfaces of the sheet member 140 are adhered by an adhesive when joined portions of the sheet member 140, such as the adhered portion 182, is formed.

In the above-described embodiment, the configuration has been described in which the non-adhered portion 181 is provided at each corner portion of the bottom surface 124 of the reagent container 100, but there is no limitation to this. The non-adhered portion needs only to be provided at at least one corner portion of the bottom surface. However, as the number of the corner portions at which the non-adhered portion is provided increases, it is possible to prevent stress from being concentrated at the corner portions when impact is applied to the reagent container 100. Accordingly, it is preferable that the non-adhered portions are provided at all of the corner portions of the bottom surface. Thereby, it is possible to prevent stress from being concentrated at any of the corner portions at the lower end of the reagent container, and to provide high impact resistance.

In the above-described embodiment, the configuration has been described in which the barrier layer 143 formed by ceramic vapor deposition is provided on the sheet member 140, but there is no limitation to this. The sheet member 140 may be provided with a barrier layer formed by aluminum vapor deposition instead of the barrier layer 143 formed by ceramic vapor deposition or may be provided with no barrier layer. However, by providing the barrier layer formed by ceramic vapor deposition rather than the barrier layer formed by aluminum vapor deposition, it is possible to restrain the thermal conductivity, and therefore, this is preferable in that it is possible to reliably melt only the portion desired to be melted when the polyethylene layer is melted.

In the above-described embodiment, the configuration has been described in which the polyethylene layers 142 and 144 are provided on the sheet member 140, but there is no limitation to this. The coated layer of the sheet member may be formed of polyolefin other than polyethylene, such as polypropylene, ethylene-propylene copolymer and polybutene-1, or thermoplastic resin other than polyolefin, such as polyamide and polyester.

In the above-described embodiment, the reagent container for housing 4 liters of the reagent has been described, but there is no limitation to 4 liters, and the present invention may be applied to reagent containers for housing 1 to 5 liters of the reagent.

In the above-described embodiment, no reinforcing member is provided at the lower end of the reagent container 100, but a reinforcing member may be provided at the lower end of the reagent container 100 in order to further enhance the strength of the reagent container 100. For example, a tape may be applied near the lower end of the body portion of the reagent container 100.

The foregoing detailed description and accompanying drawings have been provided by way of explanation and illustration, and are not intended to limit the scope of the appended claims. Many variations in the presently preferred embodiments illustrated herein will be obvious to one of ordinary skill in the art, and remain within the scope of the appended claims and their equivalents.

What is claimed is:

1. A reagent container for a biological sample analyzer that is formed of a paper sheet member for housing a reagent to be used in the biological sample analyzer, comprising:
a bottom surface; and
side wall surfaces connected to the bottom surface,
wherein the bottom surface is formed by folding one end side of a tubular body with a prismatic tubular shape formed of the sheet member and adhering overlapping surfaces to each other, and
the overlapping surfaces are not adhered to each other in a predetermined region including an apex of the bottom surface.

2. The reagent container for a biological sample analyzer according to claim 1,
wherein the biological sample analyzer is a hemocyte analyzer for analyzing hemocytes in blood.

3. The reagent container for a biological sample analyzer according to claim 2,
wherein the hemocyte analyzer includes a measurement unit for measuring the hemocytes in blood using flow cytometry.

4. The reagent container for a biological sample analyzer according to claim 1,
wherein the predetermined regions in which the overlapping surfaces are not adhered to each other are separately provided with respect to all of apexes of the bottom surface.

5. The reagent container for a biological sample analyzer according to claim 1,
wherein the predetermined region in which the overlapping surfaces are not adhered to each other includes a line segment that extends from the apex of the bottom surface and is shared with one side of the bottom surface, and
a length of the line segment is 5 mm or more and 15 mm or less.

6. The reagent container for a biological sample analyzer according to claim 1,
wherein the predetermined region in which the overlapping surfaces are not adhered to each other includes a line segment that extends from the apex of the bottom surface and is shared with one side of the bottom surface, and a length of the line segment is 3% or more and 18% or less with respect to a length of the one side of the bottom surface.

7. The reagent container for a biological sample analyzer according to claim 1,
wherein the sheet member has a paper substrate layer and a thermoplastic resin layer, and
the bottom surface is formed by welding the thermoplastic resin layers of surfaces that overlap each other by folding the one end side of the tubular body.

8. The reagent container for a biological sample analyzer according to claim 7,
wherein the sheet member has a barrier layer formed by ceramic vapor deposition between the substrate layer and the thermoplastic resin layer.

9. The reagent container for a biological sample analyzer according to claim 1, comprising:
an upper surface formed by folding the other end side of the tubular body and adhering overlapping surfaces to each other.

10. The reagent container for a biological sample analyzer according to claim 1,
which houses a reagent containing a surfactant.

11. The reagent container for a biological sample analyzer according to claim 10,
wherein the biological sample is blood, and
the reagent is a hemolyzing agent for hemolyzing erythrocytes in the blood.

12. The reagent container for a biological sample analyzer according to claim 10,
wherein the biological sample is blood, and
the reagent is a diluting solution for diluting the blood.

13. The reagent container for a biological sample analyzer according to claim 1,
wherein the tubular body has a quadrangular cross-section,
a belt-shaped portion that is provided in a belt shape along the one end, a pair of first rectangular portions that are connected to the belt-shaped portion and oppose each other, and a pair of second rectangular portions that are connected to the belt-shaped portion and oppose each other are provided on the one end side of the tubular body, and
the bottom surface is formed by folding the pair of first rectangular portions, the pair of second rectangular portions and the belt-shaped portion and adhering regions other than apex portions of the first rectangular portions and the second rectangular portions in overlapping surfaces.

14. The reagent container for a biological sample analyzer according to claim 13,
wherein a portion of an inner surface of the first rectangular portion and a portion of an inner surface of the second rectangular portion that is adjacent to the first rectangular portion are adhered to each other.

15. The reagent container for a biological sample analyzer according to claim 14,
wherein the pair of first rectangular portions and the pair of second rectangular portions are folded by folding the pair of first rectangular portions toward the inner side of the tubular body and pressing the pair of second rectangular portions so as to overlap the pair of folded first rectangular portions.

16. The reagent container for a biological sample analyzer according to claim 15,
wherein the side wall surface has a pair of third rectangular portions that are connected to the pair of first rectangular portions and oppose each other,
the first rectangular portion includes a first side shared with the third rectangular portion and a second side facing the first side, and
the pair of first rectangular portions are folded toward the inner side of the tubular body along a first straight line that joins a first apex at one end on the first side and a middle point of the second side and a second straight line that joins a second apex at the other end of the first side and the middle point of the second side.

17. The reagent container for a biological sample analyzer according to claim 16,
wherein the side wall surface has a pair of fourth rectangular portions that are connected to the pair of second rectangular portions and oppose each other,
the second rectangular portion includes a third side shared with the fourth rectangular portion and a fourth side facing the third side,
a first right triangle that includes the first straight line as an oblique side and a second right triangle that includes the second straight line as an oblique side are formed in the first rectangular portion,
a third right triangle including, as an oblique side, a third straight line that joins a third apex at one end of the third side and a middle point of the fourth side and a fourth right triangle including, as an oblique side, a fourth straight line that joins a fourth apex at the other end of the third side and the middle point of the fourth side are formed in the second rectangular portion, and
the pair of first rectangular portions and the pair of second rectangular portions are folded so that an inner surface of the first right triangle comes into contact with an inner surface of the fourth right triangle adjacent to the first right triangle and an inner surface of the second right triangle comes into contact with an inner surface of the third right triangle adjacent to the second right triangle.

18. The reagent container for a biological sample analyzer according to claim 17,
wherein a region including the first apex of the first right triangle and a region including the fourth apex of the fourth right triangle are not adhered to each other, and
a region including the second apex of the second right triangle and a region including the third apex of the third right triangle are not adhered to each other.

19. A method for manufacturing a reagent container for a biological sample analyzer for housing a reagent to be used in the biological sample analyzer using a sheet member including a paper substrate layer and a thermoplastic resin layer, comprising steps of:
forming a tubular body that has a quadrangular cross-section using the sheet member,
melting the thermoplastic resin layer at a region other than a portion that becomes a corner portion of a bottom surface of the reagent container on one end side of the tubular body, and
forming the bottom surface by folding the one end side of the tubular body and welding the thermoplastic resin layers of overlapping surfaces.

20. The method for manufacturing a reagent container for a biological sample analyzer according to claim 19,
wherein the corner portion in which the thermoplastic resin layers are not welded includes a line segment that extends from an apex of the bottom surface and is shared with one side of the bottom surface, and
a length of the line segment is 3% or more and 18% or less with respect to a length of the one side of the bottom surface.
